(19) United States
(12) Patent Application Publication
(10) Pub. No.: US 2024/0331116 A1
(43) Pub. Date: Oct. 3, 2024

(54) MEDICAL IMAGE PROCESSING APPARATUS, MAGNETIC RESONANCE IMAGING APPARATUS, AND MEDICAL IMAGE PROCESSING METHOD

(71) Applicant: CANON MEDICAL SYSTEMS CORPORATION, Otawara-shi (JP)

(72) Inventors: Shun UEMATSU, Nasushiobara (JP); Hideaki KUTSUNA, Kawasaki (JP); Kensuke SHINODA, Otawara (JP); Mitsuhiro BEKKU, Utsunomiya (JP); Hana TOCHIBORI, Yokohama (JP)

(73) Assignee: CANON MEDICAL SYSTEMS CORPORATION, Otawara-shi (JP)

(21) Appl. No.: 18/619,922

(22) Filed: Mar. 28, 2024

(30) Foreign Application Priority Data
Mar. 31, 2023 (JP) 2023-058906

(51) Int. Cl. G06T 5/80; G06T 5/20; G06T 5/60; G06T 5/70

(52) U.S. Cl. CPC G06T 5/80; G06T 5/20; G06T 5/60; G06T 5/70; G06T 2207/10088; G06T 2207/20084; G06T 2207/30004

(57) ABSTRACT

A medical image processing apparatus according to one embodiment includes processing circuitry. The processing circuitry obtains input medical image data having a larger image region than output medical image data as a result of image processing; determines, in the input medical image data, a region that is smaller than the image region of the input medical image data and that is to affect image quality of the output medical image data when the image processing is applied to the input medical image data; performs the image processing to the determined region in the input medical image data; and outputs the output medical image data resulting from the image processing performed.

### CROSS-REFERENCE TO RELATED APPLICATIONS

This application is based upon and claims the benefit of priority from Japanese Patent Application No. 2023-058906, filed on Mar. 31, 2023, the entire contents of which are incorporated herein by reference.

### FIELD

Embodiments described herein relate generally to a medical image processing apparatus, a magnetic resonance imaging apparatus, and a medical image processing method.

### BACKGROUND

Conventionally, magnetic resonance imaging apparatuses may image a wider region than the field of view of a final image to be output (hereinafter, referred to as a final output image) in view of reducing wraparound artifacts, for example. In this regard, a conventional approach is that considering influences on the image quality of final output images, all the data across the wider region is subject to heavy-load, time-consuming image processing such as super-resolution processing. Because of this, it may disadvantageously take a large amount of time to obtain final output images in such a conventional manner.

### BRIEF DESCRIPTION OF THE DRAWINGS

FIG. 1 is a block diagram illustrating an exemplary medical image processing apparatus according to an embodiment;

FIG. 2 illustrates an MRI apparatus according to an embodiment by way of example;

FIG. 3 illustrates an example of a region to which a distortion correction process is applied, according to an embodiment;

FIG. 4 illustrates an example of a distortion correction region according to an embodiment;

FIG. 5 illustrates an example of an image-quality enhancement region which is determined based on the distortion correction region, a CNN kernel that implements an image-quality enhancement process, and the number of convolution layers, according to an embodiment;

FIG. 6 illustrates an example of performing a noise reduction process, an artifact reduction process, and a GDC process in this order according to an embodiment;

FIG. 7 is a flowchart illustrating steps of image processing according to an embodiment by way of example;

FIG. 8 illustrates an example of a unitary region to which image processing including an image-quality enhancement process (CNN) and a distortion correction process is applied, according to a first application of one embodiment, and

FIG. 9 illustrates an example of a region to which image processing is applied using mask data, according to a second application of one embodiment.

### DETAILED DESCRIPTION

According to one embodiment, a medical image processing apparatus includes processing circuitry. The processing circuitry obtains input medical image data having a larger image region than output medical image data as a result of image processing. The processing circuitry determines, in the input medical image data, a region that is smaller than the image region of the input medical image data and that is to affect image quality of the output medical image data when the image processing is applied to the input medical image data. The processing circuitry performs the image processing to the determined region in the input medical image data. The processing circuitry outputs the output medical image data resulting from the image processing performed.

Hereinafter, embodiments of a medical image processing apparatus, a magnetic resonance imaging (MRI) apparatus, and a medical image processing method will be described in detail with reference the accompanying drawings.

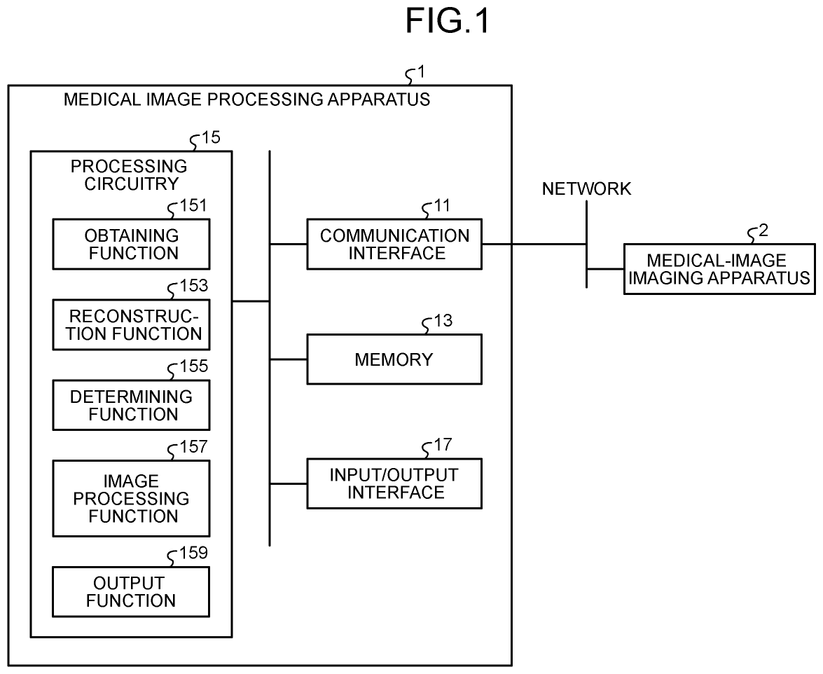

FIG. 1 is a block diagram illustrating an example of a medical image processing apparatus 1. The medical image processing apparatus 1 may be incorporated in, for example, any of various kinds of modalities capable of generating medical images or in an in-hospital server. The medical image processing apparatus 1 includes various functions, which may be incorporated in a picture archiving and communication systems (PACS) server or a hospital information system (HIS) server, for example. In such a case the medical image processing apparatus 1 is connected via a network to any suitable medical-image imaging apparatus 2 that can perform magnetic resonance imaging. The medical-image imaging apparatus 2 corresponds to, for example, a known MRI apparatus.

The medical image processing apparatus 1 including the various functions are exemplified by an MRI apparatus, a positron emission tomography (PET)-MRI apparatus, and a single photon emission computed tomography (SPECT)-MRI apparatus. In the following the medical image processing apparatus 1 is defined to be included in an MRI apparatus for the sake of specificity. Such a MRI apparatus includes various kinds of functions of processing circuitry 15.

### Embodiment

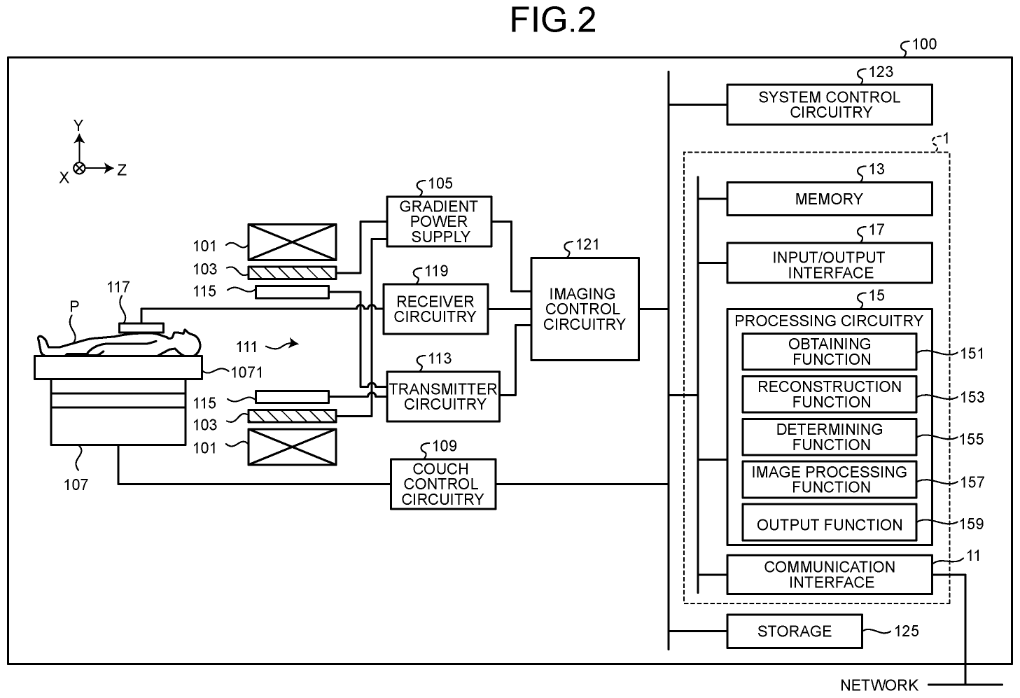

FIG. 2 illustrates an MRI apparatus 100 according to the present embodiment by way of example. In the MRI apparatus 100 as illustrated in FIG. 2, the medical image processing apparatus 1 further includes an input/output interface 17. However, the medical image processing apparatus 1 may not incorporate the input/output interface 17, as illustrated in FIG. 1. As illustrated in FIG. 2, the MRI apparatus 100 includes magnetostatic magnets 101, gradient coils 103, a gradient power supply 105, a couch 107, couch control circuitry (system control unit) 109, transmitter circuitry 113, a transmission coil 115, a reception coil 117, receiver circuitry 119, imaging control circuitry (acquirer unit) 121, system control circuitry (system control unit) 123, a storage 125, and the medical image processing apparatus 1.

The magnetostatic magnets 101 are hollow, substantially cylindrical magnets. The magnetostatic magnets 101 generate substantially uniform magnetostatic fields in the internal space. Examples of the magnetostatic magnet 101 include a superconductive magnet.

The gradient coils 103 are hollow, substantially cylindrical coils and are disposed inside a cylindrical cooling container. The gradient coils 103 are individually supplied with currents to generate gradient magnetic fields which vary in magnetic strength along mutually orthogonal axes X, Y, and Z. The X, Y, and Z-axial gradient magnetic fields generated by the gradient coils 103 serve as, for example, a slice-selective gradient magnetic field, a phase-encoding gradient magnetic field, and a frequency-encoding gradient magnetic field (also referred to as readout gradient magnetic field). The slice-selective gradient magnetic field is used for optionally determining an imaging view. The phase-encoding gradient magnetic field is used for changing a magnetic resonance (MR) signal in phase in accordance with a spatial position. The frequency-encoding gradient magnetic field is used for varying the MR signal in frequency in accordance with a spatial position.

The gradient power supply 105 is a power supply unit that supplies currents to the gradient coils 103 under the control of the imaging control circuitry 121.

The couch 107 includes a couchtop 1071 on which a subject P is to be laid. Under the control of the couch control circuitry 109, the couch 107 inserts the couchtop 1071 on which the subject P is lying into a bore 111.

The couch control circuitry 109 serves to control the couch 107. The couch control circuitry 109 drives the couch 107 in response to an operator's instruction given via the input/output interface 17 to move the couchtop 1071 longitudinally and vertically, and horizontally in some situation.

The transmitter circuitry 113 supplies high frequency pulses modified with the Larmor frequency to the transmission coils 115 under the control of the imaging control circuitry 121. The transmitter circuitry 113 includes, for example, an oscillator, a phase selector, a frequency converter, an amplitude modifier, and a radio frequency (RF) amplifier. The oscillator generates RF pulses at a resonance frequency specific to target atomic nuclei in the magnetostatic field. The phase selector selects the phase of the RF pulses generated by the oscillator. The frequency converter converts the frequency of the RF pulses output from the phase selector. The amplitude modifier modifies the frequency of the RF pulses output from the frequency converter by, for example, a sinc function. The RF amplifier amplifies the RF pulses output from the amplitude modifier for supply to the transmission coils 115.

The transmission coils 115 are RF coils located inside the gradient coils 103. The transmission coils 115 generate RF pulses which correspond to a high-frequency magnetic field, in accordance with an output from the transmitter circuitry 113.

The reception coil 117 is an RF coil located in-between the gradient coils 103. The reception coil 117 receives MR signals radiated from the subject P due to a high frequency magnetic field. The reception coil 117 outputs the MR signals to the receiver circuitry 119 upon receipt. The reception coil 117 is, for example, a coil array including one or more, or typically two or more coil elements. In the following, the reception coil 117 is defined as a coil array including two or more coils for the sake of specificity.

The reception coil 117 may be composed of a single coil element. Although the transmission coils 115 and the reception coil 117 are depicted as independent RF coils in FIG. 2, the transmission coil 115 and the reception coil 117 may be united into one coil as a transmission/reception coil. The transmission/reception coil is, for example, a local transmission/reception RF coil adapted to a region of the subject P to be imaged, such as a head coil.

The receiver circuitry 119 generates digital MR signals (hereinafter, MR data) from the MR signals output from the reception coil 117 under the control of the imaging control circuitry 121. Specifically, the receiver circuitry 119 subjects the MR signals output from the reception coil 117 to various kinds of signal processing, and then performs analog to digital (A/D) conversion to the resultant MR signals to generate MR data. The receiver circuitry 119 transmits the MR data to the imaging control circuitry 121. For example, the MR data is generated for each of the coil elements and output to the imaging control circuitry 121 together with identification tags for the respective coil elements.

The imaging control circuitry 121 acquires the MR data by magnetic resonance imaging of the subject P. Specifically, the imaging control circuitry 121 controls the gradient power supply 105, the transmitter circuitry 113, and the receiver circuitry 119 in accordance with an imaging protocol output from the processing circuitry 15, to perform imaging of the subject P. The imaging protocol includes a pulse sequence depending on an examination type. The imaging protocol defines a magnitude of current to be supplied from the gradient power supply 105 to the gradient coils 103, current supply timing from the gradient power supply 105 to the gradient coils 103, a magnitude and a period of a high frequency pulse to be supplied from the transmitter circuitry 113 to the transmission coil 115, high-frequency pulse supply timing from the transmitter circuitry 113 to the transmission coil 115, and timing at which the reception coil 117 receives the MR signals, for example. The imaging control circuitry 121 drives the gradient power supply 105, the transmitter circuitry 113, and the receiver circuitry 119 to image the subject P, receives resultant MR data from the receiver circuitry 119, and transfers the MR data to the medical image processing apparatus 1. The imaging control circuitry 121 corresponds to an imaging unit.

In the following description, “processor or processors” will retrieve and execute computer programs corresponding to the various functions from a memory 13 as an example. However, it is not intended to limit the present embodiment to such an example. The processor used herein refers to, for example, circuitry such as a CPU, a graphical processing unit (GPU), an application specific unitary circuit (ASIC), a programmable logic device (e.g., simple programmable logic device (SPLD)), a complex programmable logic device (CPLD), and a field programmable gate array (FPGA).

In the case of the processor being a CPU, for example, the processor implements the functions by retrieving and executing the computer programs from the memory 13. In the case of the processor being an ASIC, the computer programs are not stored in the memory 13, instead, the functions are directly embedded in the circuitry of the processor as a logic circuit. According to the present embodiment, each processor may be configured as a single circuit, or multiple independent circuits may be combined into a single processor to implement the functions. Further, an example that a single memory circuit stores the computer programs corresponding to the processing functions will be explained below. Alternatively, multiple memory circuits may be disposed in a distributed manner, allowing the processing circuitry 15 to retrieve the corresponding computer programs from the individual memory circuits.

The system control circuitry 123 includes, as hardware resources, a processor (not shown) and memory such as read-only memory (ROM) and random access memory (RAM), and includes a system control function to control the MRI apparatus 100. Specifically, the system control circuitry 123 retrieves and loads a system control program from the storage 125 onto the memory to control the respective circuits of the MRI apparatus 100 according to the loaded system control program.

For example, the system control circuitry 123 retrieves an imaging protocol from the storage 125 according to an imaging condition input by the operator via the input/output interface 17. The system control circuitry 123 transmits the imaging protocol to the imaging control circuitry 121 to perform control over imaging of the subject P. The system control circuitry 123 may be implemented by, for example, a processor. Alternatively, the system control circuitry 123 may be incorporated in the processing circuitry 15. In this case the processing circuitry 15 performs the system control function and functions as a substitute for the system control circuitry 123.

The storage 125 stores therein a variety of computer programs to be executed by the system control circuitry 123, a variety of imaging protocols, and imaging conditions including imaging parameters that define the imaging protocols, for example. The storage 125 is, for example, a semiconductor memory device as RAM or flash memory, a hard disk drive (HDD), a solid state drive (SSD), or an optical disc. Alternatively, the storage 125 can be a driver that reads and writes various kinds of information from and to portable storage media such as a compact disc (CD)-ROM drive, a digital versatile disk (DVD) drive, and a flash memory, for example. The memory 13, rather than the storage 125, may store the various kinds of data and function as a substitute for the storage 125.

The medical image processing apparatus 1 includes a communication interface 11, the memory 13, and the processing circuitry 15. As illustrated in FIG. 1 and FIG. 2, the communication interface 11, the memory 13, and the processing circuitry 15 are electrically connected to one another via a bus in the medical image processing apparatus 1. As illustrated in FIG. 1 and FIG. 2, the medical image processing apparatus 1 is connected to a network via the communication interface 11. The network can be communicably connected to, for example, various modalities and information processing systems in a medical facility, such as a HIS and a radiology information system (RIS). The medical image processing apparatus 1 of FIG. 1 may additionally include an input interface for allowing the operator to input various instructions and a display (output interface) that displays medical images generated by an image processing function 157, or the input/output interface 17 of FIG. 2.

The communication interface 11 performs data communications with, for example, a variety of modalities that image the subject P for a medical examination, a HIS, and a PACS. The communication standard under which the communication interface 11, and the modalities and the HIS mutually communicate may be any suitable standard. Examples of the communication standard include both or either of Health Level 7 (HL7) and Digital Imaging and Communications in Medicine (DICOM).

The memory 13 can be implemented by memory circuitry that stores various kinds of information therein. The memory 13 is, for example, a storage device such as an HDD, an SSD, and an integrated circuit storage. The memory 13 corresponds to a storage unit. In addition to an HDD and an SSD, the memory 13 may be a semiconductor memory device as a RAM or a flash memory, an optical disc as a compact disc (CD) or a digital versatile disk (DVD), a portable storage medium, or a driver that reads and writes various kinds of information from and to a semiconductor memory device as a RAM, for example.

The memory 13 stores an obtaining function 151, a reconstruction function 153, a determining function 155, an image processing function 157, and an output function 159 in a computer-executable program format, each of which the processing circuitry 15 implements. The memory 13 also stores therein various kinds of data received by the obtaining function 151 via the communication interface 11. Specifically, the memory 13 stores, for example, the MR data obtained by the obtaining function 151 from the imaging control circuitry 121 or the medical-image imaging apparatus 2. The memory 13 further stores magnetic resonance (MR) images generated by the reconstruction function 153 and the image processing function 157. If the medical image processing apparatus 1 is implemented by any kind of image server, the memory 13 stores medical images obtained by the obtaining function 151.

The memory 13 further stores computer programs for various kinds of image processing to be executed by the image processing function 157, application software, trained models, and else. Images to be a subject of image processing are exemplified by MR images generated by the reconstruction function 153 and/or medical images obtained by the obtaining function 151. Hereinafter, for the sake of specificity, medical image data including images to be subject to image processing (to be input to the image processing) will be referred to as input medical image data. Medical image data having undergone image processing (to be output from the image processing) will be referred to as output medical image data.

In the present embodiment, the input medical image data has a larger image region than the output medical image data resulting from the image processing to the input medical image data. The image region in the output medical image data is preset according to a user instruction given via the input/output interface 17, for example. The image region in the output medical image data set by the user corresponds to a field of view (FOV). Thus, the image region of the input medical image data is larger than the FOV. In other words, the image region of the input medical image data includes the FOV.

The image processing includes, for example, at least either of a distortion correction process that corrects image distortions in the input medical image data and an image-quality enhancement process that enhances the input medical image data in image quality. With respect to the input medical image data being an MR image, the distortion correction process corrects image distortions arising from a distortion of a gradient field, in the input medical image data. Such image processing may be heavy-load, time-consuming processing that requires a large amount of time for computations. The specifics of the image processing are, for example, characterized by a parameter defining the image processing concerned. The distortion correction process may also be referred to as a gradient distortion correction (GDC). The distortion correction process may be any other suitable process in addition to the GDC.

The memory 13 contains, for example, a GDC lookup table listing image distortions in the input medical image data relative to the image region (FOV) in the output medical image data. At the time of shipment, installment, and/or maintenance of the MRI apparatus 100, for example, a lookup table showing image distortions arising from a gradient distortion with respect to the image region (FOV) in the output medical image data and the image region in the input medical image data may be generated. This lookup table shows, by coordinates, multiple positions (e.g., pixels) in the image region (FOV) of the output medical image data and their corresponding positions in the image region of the input medical image data, for example. The memory 13 contains such a lookup table.

The GDC corrects image distortions in the input medical image data based on image distortions in the input medical image data relative to the image region in the output medical image data. Thus, the parameter defining the distortion correction process corresponds to the lookup table showing the image distortions in the input medical image data with respect to the image region in the output medical image data. With reference to the lookup table showing the image distortions, the GDC corrects the image distortions in the input medical image data to generate output medical image data for output.

The image-quality enhancement process includes, for example, at least one of a noise reduction process and an artifact reduction process. The noise reduction process is for reducing noise in the input medical image data and the artifact reduction process is for reducing artifacts in the input medical image data.

The noise reduction process can be implemented by, for example, a trained model capable of noise reduction in the input medical image data (hereinafter, referred to as a noise reduction model) or a noise reduction filter capable of noise reduction in the input medical image data. In the noise reduction process, the noise reduction model or the noise reduction filter is applied to the input medical image data to generate output medical image data with less noise for output.

The artifact reduction process can be implemented by, for example, a trained model capable of artifact reduction (hereinafter, referred to as an artifact reduction model). Examples of artifacts reducible by the artifact reduction model include Gibbs artifacts. Gibbs artifacts may also be referred to as truncation artifacts or ringing artifacts.

The trained model serving as the noise reduction model and the artifact reduction model can be implemented by, for example, a model utilizing a pre-trained neural network by a deep neural network (DNN). Application of the trained model is exemplified by a convolutional neural network (CNN). The CNN may include, for example, at least one convolutional filter, an input layer, multiple convolutional layers, and an output layer. The convolutional filter corresponds to a convolution kernel. Different convolutional filters include different kernels in size. Any known noise reduction model and artifact reduction model are applicable, therefore, a description thereof is omitted herein.

The noise reduction filter can be implemented by known filtering using a smoothing filter, a Gaussian filter, or an edge enhancement filter. The noise reduction filter includes a kernel called a weight matrix. Any known noise reduction filter is applicable, therefore, a description thereof is omitted herein.

As described above, the image-quality enhancement process is to improve the quality of the image in the input medical image data by using any of various kinds of kernels. The parameter defining the image-quality enhancement process corresponds to a kernel size for use in the image-quality enhancement process, for example. To implement the image-quality enhancement process by a trained model as a CNN, the parameter defining the image-quality enhancement process may include the total number of convolution layers in addition to a kernel size for use in the image-quality enhancement process. As such, the image-quality enhancement process can enhance the image quality of the input medical image data using the kernel related to the image-quality enhancement process to output the output medical image data.

The processing circuitry 15 performs control of the medical image processing apparatus 1 as a whole. The processing circuitry 15 may be implemented by the processor or processors as described above. The processing circuitry 15 includes, for example, the obtaining function 151, the reconstruction function 153, the determining function 155, the image processing function 157, and the output function 159. The processing circuitry 15 implementing the obtaining function 151, the reconstruction function 153, the determining function 155, the image processing function 157, and the output function 159 corresponds to an obtainer unit, a reconstruction unit, a determiner unit, an image processing unit, and an output unit, respectively. Each of the obtaining function 151, the reconstruction function 153, the determining function 155, the image processing function 157, and the output function 159 is stored in computer-executable program format in the memory 13. The processing circuitry 15 is a processor or processors. For example, the processing circuitry 15 implements the functions corresponding to the computer programs by retrieving and executing the programs from the memory 13. In other words, having retrieved the respective programs, the processing circuitry 15 includes the obtaining function 151, the reconstruction function 153, the determining function 155, the image processing function 157, and the output function 159.

The processing circuitry 15 uses the obtaining function 151 to obtain input medical image data which has been generated by the reconstruction function 153's applying the Fourier transform to MR data. The input medical image data includes a larger image region than output medical image data having undergone the image processing by the image processing function 157, as described above. As illustrated in FIG. 2, for example, in the MRI apparatus 100 incorporating the processing circuitry 15, the obtaining function 151 obtains, as the input medical image data, a reconstructed MR image by the reconstruction function 153 from the reconstruction function 153. For another example, in the independent medical image processing apparatus 1 incorporating the processing circuitry 15 as illustrated in FIG. 1, the obtaining function 151 obtains, as the input medical image data, a medical image generated by the medical-image imaging apparatus 2 such as an MR apparatus from the medical-image imaging apparatus 2 or a medical image archiving apparatus such as a PACS via the communication interface 11. The obtaining function 151 may store the obtained input medical image data in the memory 13.

The processing circuitry 15 uses the reconstruction function 153 to reconstruct, as input medical image data, an MR image based on the MR data. Specifically, the reconstruction function 153 generates the input medical image data by applying the Fourier transform to the MR data. The reconstruction function 153 stores the resultant input medical image data in the memory 13.

The processing circuitry 15 uses the determining function 155 to determine, in the input medical image data, a region that may affect the image quality of the image region in the output medical image data when the image processing is applied to the input medical image data. The image region (FOV) of the output medical image data is included in the region that may affect the image quality of the image region of the output medical image data. Thus, the region includes the FOV and corresponds to the region which may have influences on the FOV after having undergone the image processing. Specifically, when the image processing uses pixel values outside the FOV, i.e., within the region around the outer periphery of the FOV, the region to be determined by the determining function 155 corresponds to the image region containing the FOV and the region outside the FOV in the input medical image data. The determining function 155 determines such a region in accordance with the parameter defining the image processing or a user input through the input/output interface 17. The user input may be provided at the time of FOV setting, for example. As an example, the determining function 155 may determine the region in accordance with a user's optional manual region-cropping.

In the input medical image data, the region to be determined is smaller in size than the image region. When the image processing function 157 performs image processing including the distortion correction process, for example, the determining function 155 retrieves from the memory 13 the lookup table showing image distortions in the input medical image data relative to the image region in the output medical image data. The determining function 155 uses the lookup table as the parameter defining the distortion correction process to determine, as a region to undergo the distortion correction process, the region that may affect the image quality of the output medical image data as a result of the distortion correction process applied to the input medical image data.

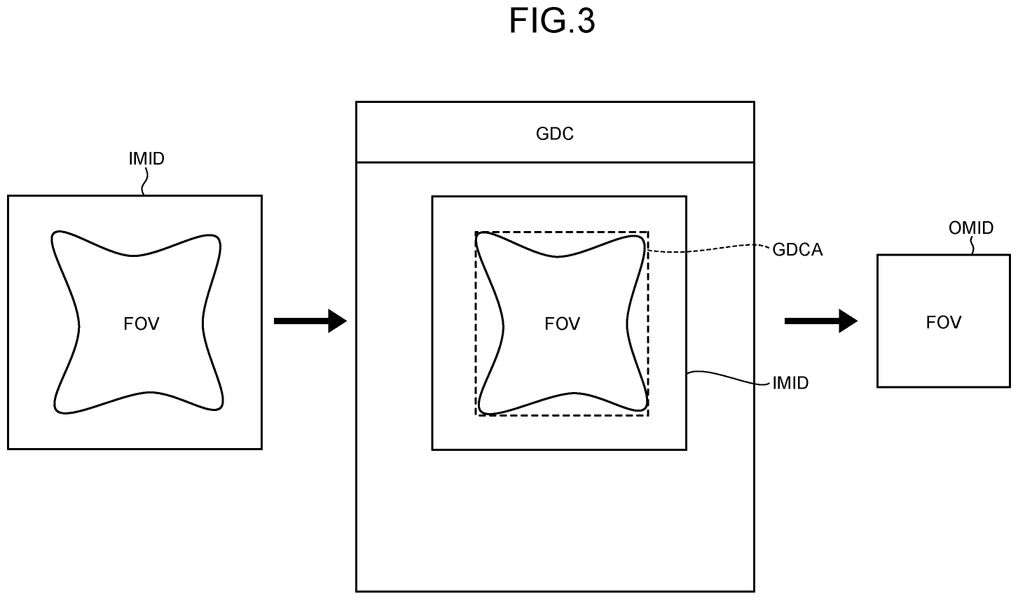

FIG. 3 illustrates an example of the region to be subject to the distortion correction process (hereinafter, a distortion correction region). In FIG. 3, the arrows indicate a flow of the distortion correction process. In FIG. 3, output medical image data OMID corresponds to the FOV. In FIG. 3, input medical image data IMID incorporates the output medical image data OMID and has a larger image region than the output medical image data OMID. Prior to the GDC, the determining function 155 sets a rectangular distortion correction region GDCA circumscribing the FOV in the input medical image data IMID with reference to the lookup table, as illustrated in FIG. 3. Specifically, the determining function 155 identifies, from the input medical image data IMID, coordinates of the four vertexes of the rectangular FOV representing the output medical image data OMID, referring to the lookup table. The determining function 155 then connects the four points identified in the input medical image data IMID to determine the distortion correction region GDCA of the input medical image data IMID.

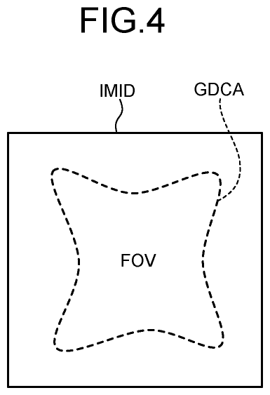

However, the distortion correction region GDCA is not limited to the rectangular region circumscribing the FOV illustrated in FIG. 3. As an example, the distortion correction region GDCA may correspond to the four sides of the rectangular FOV representing the output medical image data OMID. FIG. 4 illustrates an example of the distortion correction region. In FIG. 4, the input medical image data IMID has a distortion correction region GDCA representing output medical image data OMID as identified based on the lookup table. For example, with reference to the lookup table, the determining function 155 identifies, in the input medical image data IMID, the coordinates of the four sides of the rectangular FOV representing the output medical image data OMID. The determining function 155 then connects the four sides identified in the input medical image data IMID to determine a distortion correction region GDCA in the input medical image data IMID.

When the image processing function 157 performs image processing including the image-quality enhancement process, the determining function 155 retrieves a kernel size for use in the image-quality enhancement process from the memory 13. The determining function 155 uses the kernel size as the parameter defining the image-quality enhancement process to determine, as a region to be subject to the image-quality enhancement process (hereinafter, an image-quality enhancement region), the region that may affect the image quality of the output medical image data when the image-quality enhancement process is applied to the input medical image data. In the image processing including the image-quality enhancement process and the distortion correction process, for example, the determining function 155 determines the image-quality enhancement region based on the kernel size and the distortion correction region. In the following, the image-quality enhancement process is defined to be implemented by a CNN for the sake of specificity.

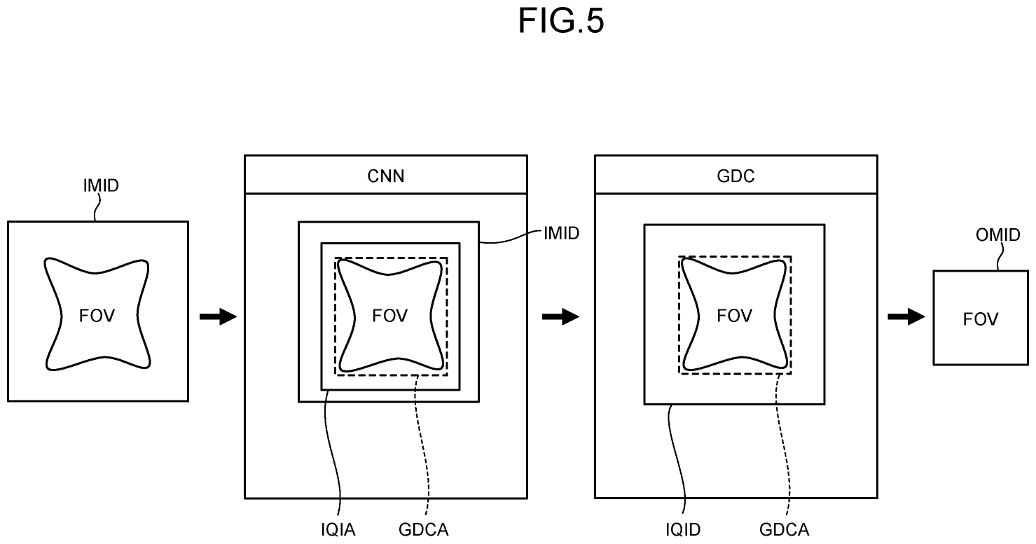

FIG. 5 illustrates an exemplary image-quality enhancement region IQIA to be determined based on the distortion correction region GDCA, a CNN kernel implementing the image-quality enhancement process, and the number of the convolution layers. As illustrated in FIG. 5, the determining function 155 determines the image-quality enhancement region IQIA in the input medical image data IMID by, for example, assigning a kernel size to the surroundings of the distortion correction region GDCA.

The processing circuitry 15 uses the image processing function 157 to perform image processing to the determined region in the input medical image data IMID. Thus, the image processing function 157 performs image processing to the region determined by the determining function 155 in the input medical image data. As an example, the image processing function 157 performs the GDC to the distortion correction region GDCA in the input medical image data IMID to generate output medical image data OMID, as illustrated in FIG. 3. The specifics of a known GDC are adoptable, therefore, a description thereof is omitted herein. In addition the image processing function 157 generates medical image data with enhanced image quality IQID (hereinafter, image-quality enhanced data) by performing the image-quality enhancement process to the image-quality enhancement region IQIA in the input medical image data IMID, as illustrated in FIG. 5. The image processing function 157 then generates the output medical image data OMID by performing the GDC to the distortion correction region GDCA in the image-quality enhanced data IQID, as illustrated in FIG. 5.

Although FIG. 5 shows execution of one image-quality enhancement process by way of example, it is not intended to limit the present embodiment to such an example. For example, multiple image-quality enhancement processes may be performed. As an example, in the image-quality enhancement process including the noise reduction process and the artifact reduction process, the image processing function 157 may perform the noise reduction process and the artifact reduction process in preset order.

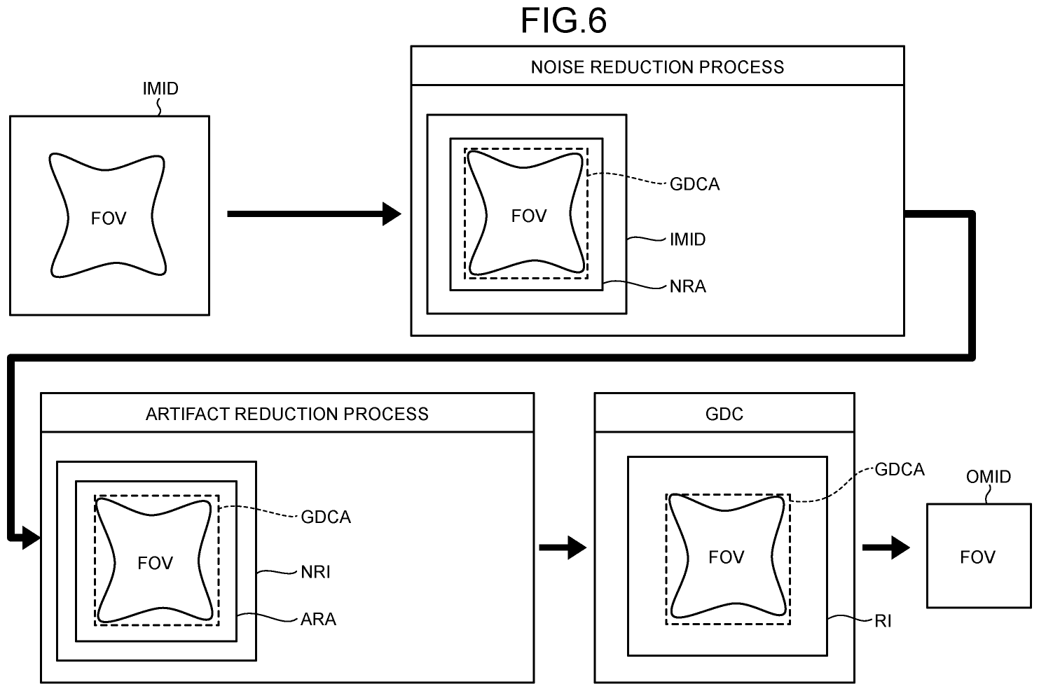

FIG. 6 illustrates an example of performing the noise reduction process, the artifact reduction process, and the GDC process in this order. FIG. 6 shows an example that the artifact reduction process follows the noise reduction process, however, it is not intended to limit the execution order of the noise reduction process and the artifact reduction process. The noise reduction process may follow the artifact reduction process, for example. As illustrated in FIG. 6, prior to the image processing, the determining function 155 determines a distortion correction region GDCA, a region to be subject to the noise reduction process (hereinafter, a noise reduction region NRA), and a region to be subject to the artifact reduction process (hereinafter, an artifact reduction region ARA). For example, the determining function 155 determines the noise reduction region NRA in advance based on, for example, the distortion correction region GDCA and a kernel size related to the noise reduction process. Also, the determining function 155 determines the artifact reduction region ARA in advance based on, for example, the distortion correction region GDCA and a kernel size related to the artifact reduction process.

The processing circuitry 15 uses the image processing function 157 to perform the noise reduction process to the noise reduction region NRA set in the input medical image data IMID to generate a noise-reduced image NRI. The image processing function 157 then performs the artifact reduction process to the artifact reduction region ARA set in the noise-reduced image NRI to generate a noise and artifact reduced image RI. The noise and artifact reduced image RI resulting from the noise reduction process and artifact reduction process applied to the input medical image data IMID is an image with less noise and less artifacts in the input medical image data. The image processing function 157 then generates output medical image data OMID by performing the GDC to the distortion correction region GDCA in the noise and artifact reduced image RI.

The processing circuitry 15 uses the output function 159 to output the output medical image data OMID as a result of performing the image processing to the determined region. As an example, the output function 159 outputs the output medical image data OMID being a result of the image processing to a display included in the input/output interface 17. For another example, the output function 159 outputs the output medical image data OMID to the memory 13 and/or the storage 125. For another example, the output function 159 outputs the output medical image data OMID to the medical image archiving apparatus as a PACS via the communication interface 11 and the network. In addition the output function 159 may output the output medical image data OMID to various kinds of servers installed inside and/or outside the hospital via the communication interface 11 and the network.

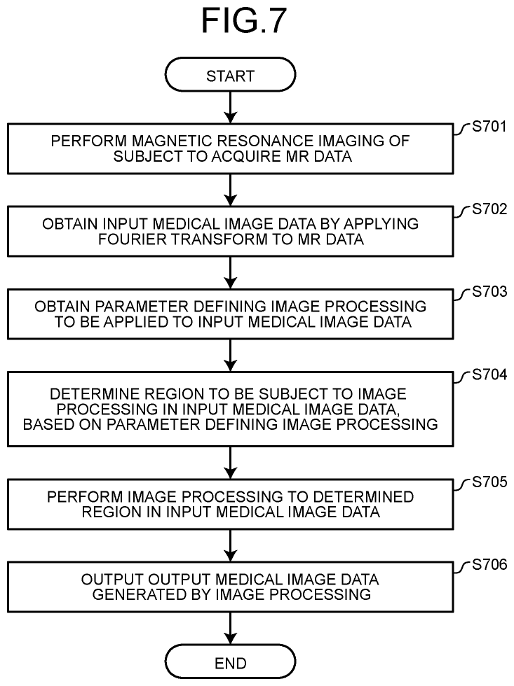

The steps of the image processing to be performed by the MRI apparatus 100 or the medical image processing apparatus 1 as configured above according to the present embodiment will be explained with reference to FIG. 7. FIG. 7 is a flowchart illustrating an example of image processing steps.

### Image Processing

### Step S701

The imaging control circuitry 121 performs magnetic resonance imaging of the subject P to acquire MR data. The imaging control circuitry 121 transfers the MR data to the medical image processing apparatus 1 and/or the storage 125. In the case of the medical image processing apparatus 1 that independently performs the image processing, as illustrated in FIG. 1, however, the obtaining function 151 obtains the MR data at step S701 of the flowchart.

### Step S702

The processing circuitry 15 uses the reconstruction function 153 to apply the Fourier transform to the MR data. In other words, the reconstruction function 153 reconstructs input medical image data IMID from the MR data. This allows the obtaining function 151 to obtain the input medical image data IMID. In a situation that the medical image processing apparatus 1 independently performs image processing and includes no reconstruction function 153, as illustrated in FIG. 1, the operation at step S701 is omissible. In this case the obtaining function 151 obtains input medical image data IMID reconstructed by the MRI apparatus from the MRI apparatus.

### Step S703

The processing circuitry 15 uses the obtaining function 151 to obtain a parameter defining the image processing to be applied to the input medical image data IMID from the memory 13. The parameter defining the image processing represents the specifics of the image processing. In the image processing being the distortion correction process (GDC), the parameter corresponds to the above-described lookup table. In the image processing being the image-quality enhancement process where the noise reduction process and/or the artifact reduction process are implemented by the filter, the parameter corresponds to the above-described kernel of the filter. In the image processing being the image-quality enhancement process where the noise reduction process and/or the artifact reduction process are implemented by the trained model (e.g., CNN), the parameter corresponds to the convolution kernel and the number of the convolution layers.

### Step S704

The processing circuitry 15 uses the determining function 155 to determine a region to be subject to the image processing in the input medical image data IMID. In the image processing being the distortion correction process, for example, the determining function 155 determines a distortion correction region GDCA in the input medical image data IMID, with reference to the lookup table serving as the parameter defining the image processing. In the image processing being the image-quality enhancement process where the trained model (e.g., CNN) implements the noise reduction process and/or the artifact reduction process, the determining function 155 determines an image-quality enhancement region IQIA based on the convolution kernel and the number of the convolution layers. In the image processing being the distortion correction process and the image-quality enhancement process, the determining function 155 determines an image-quality enhancement region IQIA in the input medical image data IMID based on the distortion correction region GDCA, the convolution kernel, and the number of the convolution layers. Alternatively, the determining function 155 may determine the region in question in accordance with a user input (e.g., cropping) via the input/output interface 17.

### Step S705

The processing circuitry 15 uses the image processing function 157 to perform the image processing to the determined region in the input medical image data IMID. In the example of FIG. 3, the image processing function 157 performs the distortion correction process to the distortion correction region GDCA in the input medical image data IMID. In the example of FIG. 5, the image processing function 157 performs the image-quality enhancement process to the image-quality enhancement region IQIA in the input medical image data IMID to generate image-quality enhanced data IQID. The image processing function 157 then performs the distortion correction process to the distortion correction region GDCA set in the image-quality enhanced data IQID.

In the example of FIG. 6, the image processing function 157 performs the noise reduction process to the noise reduction region NRA in the input medical image data IMID to generate a noise-reduced image NRI. The image processing function 157 performs the artifact reduction process to the artifact reduction region ARA set in the noise-reduced image NRI. The image processing function 157 then performs the distortion correction process to the distortion correction region GDCA set in the noise and artifact reduced image RI. In this manner the output medical image data OMID is generated at step S705.

### Step S706

The processing circuitry 15 uses the output function 159 to output the output medical image data OMID generated by the image processing. For example, the output function 159 outputs the output medical image data OMID to the display included in the input/output interface 17. In the medical image processing apparatus 1 which independently performs the image processing, as illustrated in FIG. 1, the output function 159 outputs the output medical image data OMID to the medical image archiving apparatus as a PACS or a viewer via the communication interface 11 and the network. This completes the image processing according to the present embodiment.

According to the embodiments as above, the MRI apparatus 100 and the medical image processing apparatus 1 obtain input medical image data IMID having a larger image region than output medical image data OMID resulting from image processing; determine, in the input medical image data IMID, a region that is smaller than the image region of the input medical image data IMID and that is to affect the image quality of the output medical image data OMID when the image processing is applied to the input medical image data IMID; perform the image processing to the determined region in the input medical image data IMID; and output the output medical image data OMID resulting from the image processing to the determined region.

Further, according to another embodiment, the image processing which the MRI apparatus 100 and the medical image processing apparatus 1 perform includes at least one of the image-quality enhancement process for enhancing the image quality of the input medical image data IMID and the distortion correction process for correcting image distortions in the input medical image data IMID. According to another embodiment, the MRI apparatus 100 and the medical image processing apparatus 1 determine the region to be subject to the image processing based on the parameter defining the image processing or a user input. According to another embodiment, the image-quality enhancement process which the MRI apparatus 100 and the medical image processing apparatus 1 perform includes at least one of the noise reduction process for reducing noise in the input medical image data IMID and the artifact reduction process for reducing artifacts in the input medical image data IMID.

According to one embodiment, in the MRI apparatus 100 and the medical image processing apparatus 1 which perform the image processing including the distortion correction process, the parameter defining the image processing corresponds to the lookup table showing image distortions in the input medical image data IMID relative to the image region in the output medical image data OMID. With reference to the lookup table, the MRI apparatus 100 and the medical image processing apparatus 1 according to one embodiment determine, as a region to be subject to the distortion correction process, the region that is to affect the image quality of the output medical image data OMID when the distortion correction process is applied to the input medical image data IMID.

According to the MRI apparatus 100 and the medical image processing apparatus 1 of another embodiment that perform the image processing including the image-quality enhancement process, the parameter defining the image-quality enhancement process corresponds to a kernel size for use in the image-quality enhancement process. Based on the kernel size and the region to be subject to the distortion correction process, the MRI apparatus 100 and the medical image processing apparatus 1 of one embodiment determine, as a region to be subject to the image-quality enhancement process, a region that is to affect the image quality of the output medical image data OMID when the image-quality enhancement process is applied to the input medical image data IMID.

As such, the MRI apparatus 100 and the medical image processing apparatus 1 of one embodiment can perform image processing to the data region being smaller in size than that of the input medical image data IMID and to have an influence on the image quality of the output medical image data (FOV) OMID. Namely, the MRI apparatus 100 and the medical image processing apparatus 1 of one embodiment can determine the region that is to affect the image quality of the FOV, and then perform image processing to that region. Because of this, the MRI apparatus 100 and the medical image processing apparatus 1 of one embodiment can ensure the image quality of the output medical image data (FOV) OMID in the level similar to the conventional level as well as can improve the image processing speed from the conventional speed owing to a smaller data region to undergo image processing than the conventional data region.

### First Application

A first application concerns applying multiple pieces of image processing to the input medical image data IMID and determining a region to be subject to all the multiple pieces of image processing (hereinafter, referred to as a unitary region), considering the details of the multiple pieces of image processing. For example, in the image-quality enhancement process including the noise reduction process and the artifact reduction process, the processing circuitry 15 uses the determining function 155 to determine, as the region (unitary region) to be subject to the image-quality enhancement process, the region that is to affect the image quality of the output medical image data OMID when the image-quality enhancement process is applied to the input medical image data IMID, by using a larger one of a kernel related to the noise reduction process and a kernel related to the artifact reduction process. Alternatively, the determining function 155 may determine the region to be subject to the image-quality enhancement process, based on the distortion correction region GDCA. Thus, the determining function 155 can determine the unified image processing region (unitary region) for the image processing including the image-quality enhancement process and the distortion correction process.

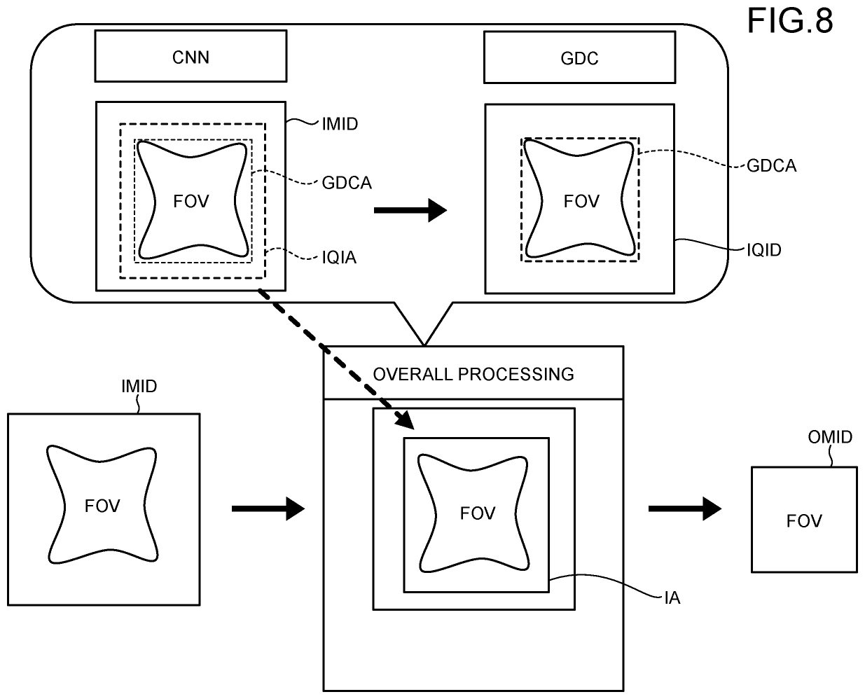

FIG. 8 illustrates an example of a unitary region IA to which the image processing including the image-quality enhancement process (CNN) and the distortion correction process is applied. As illustrated in FIG. 8, the unitary region IA incorporates the distortion correction region GDCA, and thus the unitary region IA corresponds to the image-quality enhancement region IQIA. In this case the processing circuitry 15 uses the image processing function 157 to perform both the image-quality enhancement process (CNN) and the distortion correction process to the unitary region IA.

According to the first application of the embodiments as explained above, in the image-quality enhancement process including both the noise reduction process and the artifact reduction process, the MRI apparatus 100 and the medical image processing apparatus 1 determine, as a region to be subject to the image-quality enhancement process, the region that is to affect the image quality of the output medical image data OMID when the image-quality enhancement process is applied to the input medical image data IMID, by using a larger one of a kernel related to the noise reduction process and a kernel related to the artifact reduction process, for example. This eliminates the necessity for the MRI apparatus 100 and the medical image processing apparatus 1 of the first application to determine the region to be subject to image processing in accordance with the details of the image processing concerned, leading to reducing the computational cost for setting such a region. The rest of the effects are similar to or the same as the embodiments, therefore, a description thereof is omitted herein.

### Second Application

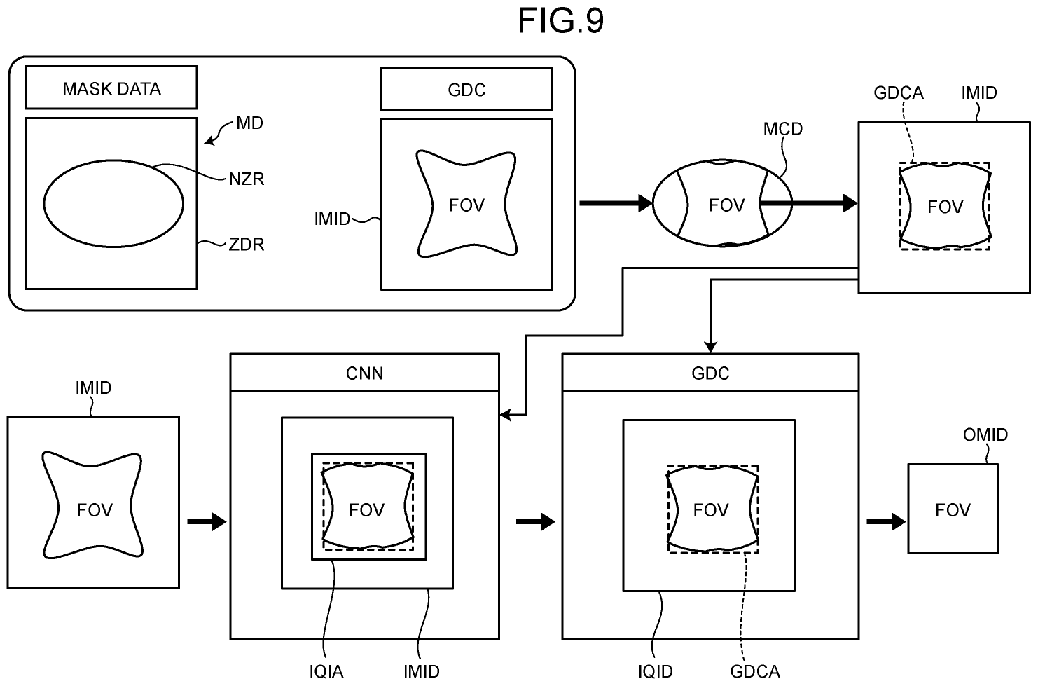

A second application concerns the input medical image data IMID reconstructed by parallel imaging and determining, in the reconstructed image data, a region to be subject to the image processing by using a mask for a sensitivity map in the parallel imaging. For example, the processing circuitry 15 uses the obtaining function 151 to obtain mask data of a sensitivity map used in the generation of the input medical image data IMID from, for example, the memory 13. In the medical image processing apparatus 1 which independently performs image processing, however, the obtaining function 151 obtains the mask data from the MRI apparatus having generated the input medical image data IMID. The mask data corresponds to, for example, data in which pixels with sensitivity less than a predetermined threshold in the sensitivity map are substituted with zero (i.e., data filled with zeros, ZDR in FIG. 9).

The processing circuitry 15 uses the determining function 155 to further use the input medical image data IMID having the obtained mask data applied thereto, to determine a region to be subject to the image processing. For example, the determining function 155 applies the mask data to the FOV in the input medical image data IMID. Thereby, data on the FOV with the values (NZR in FIG. 9) other than zero cropped (hereinafter, mask cropped data) can be extracted from the input medical image data IMID. Namely, the FOV can be cropped or cut out from the input medical image data IMID using the mask data. Next, the determining function 155 determines a distortion correction region GDCA in the mask cropped data, with reference to the above-described lookup table. For example, the determining function 155 determines, as the distortion correction region GDCA, a rectangular region circumscribing the FOV in the mask cropped data of the input medical image data IMID. Alternatively, the determining function 155 may determine, as the distortion correction region GDCA, the region corresponding to the mask cropped data of the input medical image data IMID. The determining function 155 then determines the region to be subject to the image-quality enhancement process using the distortion correction region GDCA and the kernel related to the image-quality enhancement process, as in the embodiments.

FIG. 9 illustrates an example of the region to which the image processing using mask data MD is applied. As illustrated in FIG. 9, mask cropped data MCD is generated by applying the mask data MD to the input medical image data IMID. As illustrated in FIG. 9, the distortion correction region GDCA is a rectangular region circumscribing the FOV in the mask cropped data MCD of the input medical image data IMID. The image-quality enhancement region IQIA is determined using, for example, the distortion correction region GDCA determined based on the mask cropped data MCD and the kernel related to the image-quality enhancement process.

According to the second application of the embodiments as described above, the MRI apparatus 100 and the medical image processing apparatus 1 obtain the mask data MD of the sensitivity map used in the generation of the input medical image data IMID, and further uses the input medical image data IMID having the mask data MD applied thereto (mask cropped data MCD) to determine the region to be subject to the image processing. According to the second application, it is thus possible to further scale down the region to be subject to the image processing as illustrated in FIG. 9, in comparison with the region in FIG. 6. As such, the second application can provide further improvement in the image processing speed while ensuring the image quality of the output medical image data (FOV) OMID in the level similar to the conventional level.

To implement the technical idea of one embodiment by a medical image processing method, the medical image processing method includes obtaining input medical image data IMID having a larger image region than output medical image data OMID resulting from image processing; determining, in the input medical image data IMID, a region that is smaller than the image region of the input medical image data IMID and that is to affect the image quality of the output medical image data OMID when the image processing is applied to the input medical image data IMID; performing the image processing to the determined region in the input medical image data IMID; and outputting the output medical image data OMID resulting from the image processing to the determined region. The procedure and effects of the medical image processing performed by the image processing method are similar to or the same as those of the embodiments, therefore, a description thereof is omitted herein.

To implement the technical idea of one embodiment by a medical image processing program, the medical image processing program causes the computer to obtain input medical image data IMID having a larger image region than output medical image data OMID resulting from image processing; determine, in the input medical image data IMID, a region that is smaller than the image region of the input medical image data IMID and that is to affect the image quality of the output medical image data OMID when the image processing is applied to the input medical image data IMID; perform the image processing to the determined region in the input medical image data IMID; and output the output medical image data OMID resulting from the image processing to the determined region. The medical image processing program may be stored in, for example, a computer-readable, nonvolatile storage medium.

As an example, the medical image processing program may be installed in any of various kinds of image processing servers (processing apparatus) from the nonvolatile storage medium, and loaded on the memory to be able to implement the image processing. In this case the program for causing the computer to execute the image processing can be stored and distributed in a storage medium such as a magnetic disk (e.g., hard disk), an optical disk (e.g., CD-ROM, DVD), or a semiconductor memory. The procedure and effects of the medical image processing program are similar to or the same as those in the embodiments, therefore, a description thereof is omitted herein.

According to at least one of the embodiments as described above, it is possible to shorten the length of image processing time while ensuring the image quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image processing apparatus comprising:
processing circuitry configured to:
obtain input medical image data having a larger image region than output medical image data as a result of image processing,
determine, in the input medical image data, a region that is smaller than the image region of the input medical image data and that is to affect image quality of the output medical image data when the image processing is applied to the input medical image data,
perform the image processing to the determined region in the input medical image data, and
output the output medical image data resulting from the image processing performed.

2. The medical image processing apparatus according to claim 1, wherein
the image processing includes at least one of an image-quality enhancement process for enhancing image quality of the input medical image data and a distortion correction process for correcting image distortion in the input medical image data.

3. The medical image processing apparatus according to claim 2, wherein
the processing circuitry is further configured to determine the region according to a parameter defining the image processing or a user input.

4. The medical image processing apparatus according to claim 3, wherein
in the image processing including the distortion correction process, the parameter defining the image processing is a lookup table showing image distortion in the input medical image data with respect to the image region of the output medical image data, and
the processing circuitry is further configured to determine, as a region to be subject to the distortion correction process, with reference to the lookup table, the region that is to affect the image quality of the output medical image data when the distortion correction process is applied to the input medical image data.

5. The medical image processing apparatus according to claim 3, wherein
in the image processing including the image-quality enhancement process, the parameter defining the image processing is a kernel size to be used in the image-quality enhancement process, and
the processing circuitry is further configured to determine, as a region to be subject to the image-quality enhancement process, based on the kernel size and the region to be subject to the distortion correction process, the region that is to affect the image quality of the output medical image data when the image-quality enhancement process is applied to the input medical image data.

6. The medical image processing apparatus according to claim 5, wherein
the image-quality enhancement process includes at least one of a noise reduction process for reducing noise in the input medical image data and an artifact reduction process for reducing artifacts in the input medical image data.

7. The medical image processing apparatus according to claim 6, wherein
in the image-quality enhancement process including the noise reduction process and the artifact reduction process, the processing circuitry is further configured to determine, as a region to be subject to the image-quality enhancement process, the region that is to affect the image quality of the output medical image data when the image-quality enhancement process is applied to the input medical image data, using a larger one of a kernel related to the noise reduction process and a kernel related to the artifact reduction process.

8. The medical image processing apparatus according to claim 1, wherein the processing circuitry is further configured to:
obtain mask data of a sensitivity map used in generation of the input medical image data, and
determine the region based on the input medical image data having the mask data applied thereto.

9. A magnetic resonance imaging apparatus comprising:
imaging control circuitry configured to perform magnetic resonance imaging of a subject to acquire magnetic resonance (MR) data; and
processing circuitry configured to:
obtain input medical image data having a larger image region than output medical image data as a result of image processing, by applying Fourier transform to the MR data,
determine, in the input medical image data, a region that is smaller than the image region of the input medical image data and that is to affect image quality of the output medical image data when the image processing is applied to the input medical image data,
perform the image processing to the determined region in the input medical image data, and
output the output medical image data resulting from the image processing performed.

10. A medical image processing method comprising:
obtaining input medical image data having a larger image region than output medical image data as a result of image processing;
determine, in the input medical image data, a region that is smaller than the image region of the input medical image data and that is to affect image quality of the output medical image data when the image processing is applied to the input medical image data;
perform the image processing to the determined region in the input medical image data; and
output the output medical image data resulting from the image processing performed.
